(19) United States
(12) Patent Application Publication
(10) Pub. No.: US 2023/0150894 A1
(43) Pub. Date: May 18, 2023

(54) MANUFACTURING PROCESS FOR PRODUCING AMMONIA FROM ANAEROBIC DIGESTATE LIQUID

(71) Applicant: Timothy Stemwedel, Hanford, CA (US)

(72) Inventor: Timothy Stemwedel, Hanford, CA (US)

(21) Appl. No.: 18/092,926

(22) Filed: Jan. 3, 2023

Related U.S. Application Data
(63) Continuation of application No. 17/972,530, filed on Oct. 24, 2022.
Application No. 17/972,530 is a continuation of application No. 17/883,522, filed on Aug. 8, 2022.
Application No. 17/883,522 is a continuation of application No. 17/829,354, filed on May 31, 2022, now abandoned.
Application No. 17/829,354 is a continuation of application No. 17/581,755, filed on Jan. 21, 2022, now abandoned.
Application No. 17/581,755 is a continuation of application No. 17/368,791, filed on Jul. 6, 2021, now abandoned.
(60) Provisional application No. 63/020,008, filed on May 4, 2020.

(51) Int. Cl. C05C 3/00; C05F 11/02; C05G 1/00; C05F 17/40; C05G 5/23; C05F 17/10

(52) U.S. Cl. CPC C05C 3/00; C05F 11/02; C05F 17/15; C05F 17/40; C05G 1/00; C05G 5/23

(57) ABSTRACT

The present invention relates to organic nitrogen fertilizers and methods for producing organic nitrogen fertilizers, including retrieving high concentration organic ammonia from discarded organic material.

### FIELD OF THE INVENTION

The present invention relates to methods of extracting ammonia from digestate liquids produced through anaerobic digestion processes. The methods of the present invention yield ammonia compounds generated through biological processes and in high concentration.

### DISCUSSION OF THE BACKGROUND

Organic farming is a highly regulated segment of the agricultural industry. Government entities such as the US Department of Agriculture (USDA) and various state agencies have formulated strict rules (e.g., under the Organic Foods Production Act) governing the growing and handling techniques required for products labeled as “organic”. These regulations are generally aimed at maintaining ecological and environmental conditions, and providing healthy foods. The demand for organic foods is rapidly increasing due to environmental stewardship concerns, and consumer preference. Thus, many portions of the agricultural industry have become focused on organic alternatives to conventional methods of production, including using organic pesticides, herbicides, and fertilizers. Regulatory, environmental, and health concerns are primary reasons for using natural or organic products.

As such there is a substantial potential market for fertilizers and other products that comply with the regulations for growing, harvesting or otherwise processing and/or obtaining organic food products. However, the existing chemical fertilizers are generally prohibited in organic farming, and composts and manures are commonly used as fertilizers instead. Composts and manures are often insufficient to generate desired crop yield, and thus supplemental nitrogen is often needed in organic cropping systems. The industry has faced difficulties in finding economically efficient and effective organic chemical agents and natural materials, including nitrogen fertilizers that can be used in the industry. Thus, the agricultural industry faces significant challenges in productivity and efficiency in the area of organic farming.

There continues to be a particular need in organic farming for more effective fertilizers to replace compost and other nitrogen sources that provide insufficient nitrogen. Finding economical and efficient alternatives to existing sources of nitrogen for use in organic farming has yielded little success. Therefore, improved and efficient compositions of naturally produced nitrogenous compounds are needed.

### SUMMARY OF THE INVENTION

The present invention provides methods of extracting ammonia from digestate liquids produced through anaerobic digestion processes. The extracted ammonia can be then be incorporated into organic fertilizers compositions. The ammonia and other nitrogenous compounds may be recovered from the digestate generated by an anaerobic digestion process, which are conventionally used to process organic waste and produce methane gas. The natural sources of nitrogenous compounds may be organic wastes generated by food processing plants, bio-digesters, rendering plants, dairies, and other sources. The nitrogen compounds may also be derived from rich organic liquid materials, such as wastewater sludge, slurry from slaughter houses, fowl manures, etc.

The ammonia and nitrogen compounds captured using the present invention are extracted from natural sources of nitrogenous compounds, without chemical reactions, and thus provides an organic source of nitrogen compounds (e.g., particularly aqueous ammonia) that can be used in fertilizer compositions for use in organic farming. The resulting organic fertilizers may be liquid or solid organic fertilizers for organic agriculture obtained by extracting nitrogenous compounds from discarded organic materials. The fertilizer composition may include the organically derived nitrogenous compounds at a concentration in a range of about 3% to about 30% by weight.

The inventive method may include a process that utilizes a series of desorption and absorption stages. The removal of ammonia from solution may be accomplished at a pH in a range of about 8 to about 12 (e.g., about pH 8.5 to about pH 11) and a temperature of about 25° C. to about 70° C. (e.g., about 30° C. to about 60° C.), to allow the dissociation of ammonium ion into aqueous ammonia and a hydrogen ion. The process may also utilize the effect of temperature on the dissociation of the ammonium ion. Increased temperature results in the dissociation of ammonium at lower pH ranges allowing more ammonia recovery at a lower pH.

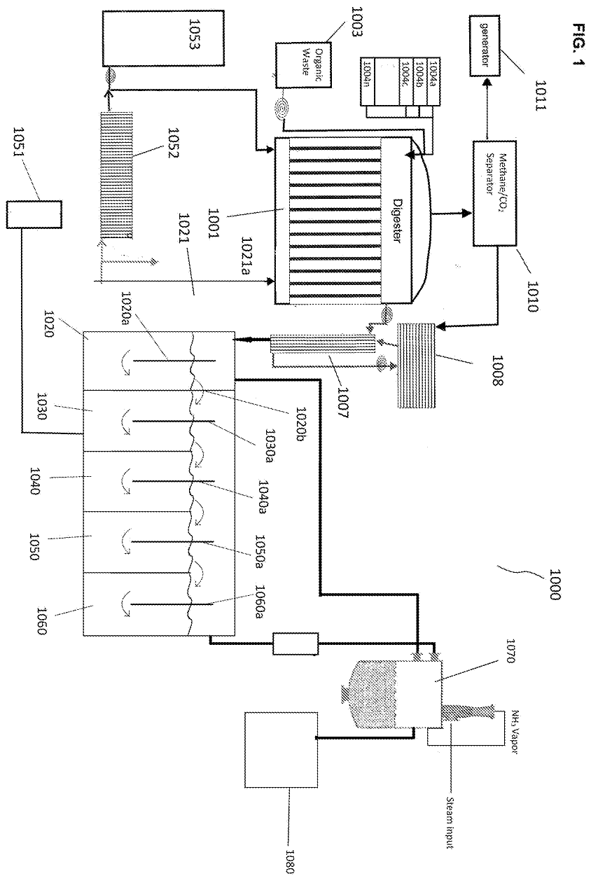

Described below is a method and system for producing an aqueous ammonia product from organic waste materials through physical processes without the need for chemical reactions, thereby yielding an organic nitrogen source that complies with current regulatory agency regulations (e.g., as the FDA and NOP) for use in organic farming. The method and system is described with reference to FIG. 1 submitted herewith. FIG. 1 provides a schematic view of an ammonia recovery system. The following description should be read with reference to FIG. 1.

The discarded organic material used for the extraction process may be from various organic substrate sources, including plant biomass, manure, other animal waste, municipal and food wastes. The discarded organic material may be processed through a non-chemical microbe-mediated digestion process to produce a liquid byproduct rich in ammonia and ammonium compounds. The digestion process may be an anaerobic digestion process that produces ammonia and ammonium compounds as byproducts. The organic materials may be utilized the extraction process disclosed herein.

In order to maximize the ammonia and ammonium compound production in the biodigestion process, a co-digestion process may be used in some embodiments. The co-digestion may utilize a balance of substrates, including a major substrate available in large amounts (e.g. manure or sewage sludge) and additional minor co-substrates present in smaller amounts for purposes of balancing the chemistry of co-digestion to facilitate the generation of ammonia and ammoniacal species in the biodigestion process. Co-digestion improves nutrient balance and digestion, equalization of solids by dilution, biogas production, and increases the potential for production of ammonia and ammonium compounds produced by natural means without chemical reactions, while producing higher yields of ammonia and ammonium compounds.

Anaerobic bacteria may be used in the biodigestion process. In biodigestion, high fermentation rates from proteins from animal derived co-substrates result in the formation of ammonia and ammoniacal species. Thus, biowastes high in proteins (e.g., slaughter house wastes) are ideal for producing a substrate for the ammonia extraction process disclosed herein. However, the production of large concentrations of ammonia in the biodigestion process can raise pH and inhibit other desirable digestion processes, such as contemporaneous methanogenesis. Thus, co-digestion with other substrates, such as manure and nutrient supplements that supply sodium, calcium, magnesium, and trace amounts of nickel, cobalt, molybdenum, and/or selenium can counter-act the effects of increased ammonia and hydrogen sulfide and other inhibitory chemical products of the anaerobic digestion. An alternative biodigestion substrate that is able to produce high levels of ammonia is a combination of manure, plant biomass, general municipal sewage, and other low-protein materials with non-synthetic high-protein supplements such as blood meal, blood, soy meal, soy derived proteins, meat meal (slaughter house waste), feather meal, fish and fish by-products, whey, milk, dairy by-products, alfalfa, corn, and sweet clover. Such proteinaceous and nutrient-rich co-substrates provide nutrients missing from biodigestion of low-protein materials and help to prevent inhibiting substances from affecting methanogenesis. Additional feedstock may include molasses, sugar beet molasses, sugar reduces molasses, and vinasse, providing high sugar content to promote anaerobic respiration. Betaine may be added as a supplemental organic nitrogen source for bacterial digestion in some implementations.

Blood meal is a high protein, low fat animal product that provides high levels of nitrogen for ammonia production. The low fat content reduces the amount of fatty acids and other byproducts that create inefficiencies in the biodigestion process. Sweet clover is a nutrient rich and widely available legume that contains 15% protein. Alfalfa is also highly digestible, readily providing the nutrients therein for the anaerobes in the biodigestion mixture. Thus, blood meal and/or sweet clover (and other high nitrogen organic matter, such as sweet clover, corn, and/or betaine) can be loaded into the digesters along with the biological materials to create a high-nitrogen effluent. The nitrogen in the effluent may be predominantly in the form of ammonia and other ammoniacal species. An exemplary substrate and additive for anaerobic digestion can comprise blood meal, whey, alfalfa, corn, sweet clover, molasses, and/or a discarded organic material (such as manure or municipal waste).

The conditions in the digestor may be maintained in ranges that are conducive to anaerobic respiration and the production of ammonia by methanogenic and other anaerobic bacteria present in the biodigestor, such as Streptococcus, Enterobacterium, and Methanolobus strains. The pH and temperature may be held in pre-determined ranges. In some embodiments, the pH of the biodigestor may be in a range of about 30° C. and about 60° C. (e.g., between about about 40° C. and about 50° C.). The temperature of the digestor may be maintained by a combination of the heat generated by the anaerobic metabolism of the anaerobic bacteria in the digestor and one or more heating mechanisms for heating feedstock for the digestor and/or the digestate fluid in the digestor. For example, the system may include a boiler that provides steam for a heat exchanger through which digestate fluid is passed to increase the temperature thereof and then the digestate fluid may be returned to the digestor. In some examples, the boiler may be fueled by methane gas that is generated in the digestor and then extracted by a methane/CO₂ separation system, further discussed below.

The pH of the biodigestor may be maintained in a pH range of about 6.5 to about 9 (e.g., in a range of about 6.8 to about 7.5, or any value therein). In some embodiments, bacterial strains that are able to thrive and produce ammonia at higher pH levels may be selected for use in the biodigestor (e.g., Methanolobus strains such as Methanolobus bombayensis, Methanolobus taylorii, and Methanohalophilus zhilinaeae). In such embodiments, the pH of the biodigestor may be maintained at a higher pH in a range of about 7 to about 9.5 (e.g., about pH 7.5 to about pH 8.5, or any pH value therein). In some examples, the pH of the digestor may be maintained at the pre-determined range by the combination of the degassing and removal of CO₂ from the digestate liquid and the addition of a basic agent into digestor as needed. For example, the digestor may include one or more pH meters that are in communication with an electronic controller that is operable to control a valve and pump for releasing a basic agent of predetermined concentration and known basicity from a storage container housing the basic agent. The basic agent may be NaOH, Ca(OH)₂, KOH, hydrated lime, or other basic agent. Hydrated lime may be used in some implementations, and is approved under some agency regulations for use on “organic” crops.

The ammonia-rich liquid effluent created by the biodigestion process may subsequently be used in the ammonia desorption process of the present invention. The method of extracting ammonia and other ammonium compounds from the effluent includes optimizing the chemical condition of the effluent by increasing the temperature and/or pH of the effluent to drive the chemical equilibrium of ammonium species (e.g., ammonium bicarbonate) and free ammonia in the effluent toward the release of more free ammonia, degassing of the effluent to remove carbon dioxide therefrom, and extracting NH₃ and ammonium compounds from the effluent. These processes allow the ammonia and ammonium species (e.g., ammonia, ammonium, ammonium hydroxide, and ammonium carbonate) in the optimized effluent to be extracted through a sequence of desorption and absorption stages in which the physical conditions of the effluent (e.g., temperature and pH) are sequentially varied to facilitate removal and reabsorption of ammonia in aqueous solution.

Digestate liquid from one or more digestor apparatus 1001 (e.g., an anaerobic digestor) may have large amounts of dissolved carbon dioxide and carbonic acid. The removal of carbon dioxide from the digestate fluid is desirable for the purposes of recovering ammonia because it raises the pH of the digestate which drives the equilibrium of ammonium species (e.g., ammonium carbonate) towards dissociation. This process of “decarbonization” results from the inverse relationship between carbon dioxide solubility in water and increased solution temperature. Carbon dioxide degasses from the digestate fluid as the temperature of the solution rises pushing the equilibrium of carbonic acid toward dissociation into CO₂ and water, thereby reducing the hydrogen ion concentration and the raising the pH of the digestate fluid. The heating of the digestate has the further effect of “deacidifying” the digestate. A significant amount of CO₂ may evolve from the digestate in the digestor, due to the sustained warm conditions therein. The pH at which CO₂ degasses from the effluent is lower than the pH at which the NH₃ degasses from the effluent and forms NH₃. As an example, CO₂ degasses from the effluent in pH range of about pH 6 to about pH 8 (e.g., about pH 6.5 to about pH 7.5) at a temperature of about 60° C., whereas NH₃ degasses from the effluent in pH range of about pH 8 to about pH 11 (e.g., about pH 8.5 to about pH 10) at a temperature of about 60° C. As the CO₂ degasses from the effluent, the effluent becomes less acidic because the equilibrium of carbonic acid and CO₂ shifts to CO₂, which then evaporates removing CO₂ and carbonic acid from the system and increasing the pH. Thus, the desorption process proceeds in a stepwise manner, with the CO₂ being removed first under lower pH conditions and the ammonia vapor being removed subsequently under higher pH conditions.

Methane may also be produced in the digestor 1001 by anaerobic bacteria contained in the mixture. The methane and CO₂ gas that evolves in the digestor 1001 may be collected via ducting and transferred to a methane/CO₂ separation system 1010. For example, a Generon® CO₂ separation system or other separation system 1010 may be used to separate the methane and CO₂ gases evolved from the digestate in the digestor 1001. The separated methane may be utilized as a fuel for a boiler 1008 for providing heated water or other fluid used in heat exchangers in the system 1000 for heating fluids at various stages of the ammonia recovery process, including heating the digestor 1001 and/or the feedstock sources 1003 and 1004a-1004n from which feedstocks are added into the digestor 1001. Steam from the boiler 1008 may also be routed to mix with the recovered ammonia and vapor at one or more mixing stages to heat the recovered ammonia product. The methane may additionally or alternatively used as a fuel for an electric generator 1011. The recovered CO₂ may be vented out of the system and/or routed to mix with a recovered ammonia vapor before the ammonia vapor is introduced into a ammonia stripping and recovery stage 1070 to lower the pH of the recovered ammonia mixture.

The digestate fluid from the digestor 1001 may be collected and heated to drive further carbon dioxide out of solution form the digestate fluid. The temperature of the digestate fluid may be raised to a temperature of about 40° C. to about 100° C., and preferably greater than 60° C. The digestate may be heated in a heat exchanger, in a heating chamber, or by other heating apparatus 1007.

The heated digestate fluid may subsequently passed from the digestor to a desorption chamber system 1021 that has multiple desorption stages for removing CO₂ and NH₃ from the digestate from the digestor in a stepwise manner. The desorption chamber system 1021 may include a plurality of sequential cells 1020, 1030, 1040, 1050, and 1060 therein through which the digestate flows, removing CO₂ gas and then NH₃ vapor in sequence. The digestate is moved into a first carbon desorption cell 1020 in which the digestate is at a temperature in a range of about 70° C. to about 100° C. (e.g., about 80° C. to about 95° C.) at a pH of about pH 6 to about pH 8 (e.g., about pH 6.5 to about pH 7.5). At these temperature and pH ranges, CO₂ bubbles out of the digestate further driving the equilibrium of carbonic acid and CO₂ toward the release of more CO₂ until the CO₂ content of the digestate falls to negligible levels. In some examples, the resulting decarbonization of the digestate may result in the digestate having a pH of about 8 to about 10 (e.g., about 8.5 to about 9.5, or any value in such range). The CO₂- rich air may be removed from the decarbonization cell 1020 for use in a later stage of the ammonia recovery process. The removal of the CO₂— rich air may be aided by a pump, a partial vacuum, or may be allowed to flow naturally from the cell 1020. The heating and mixing/injection process may remove up to about 90% of the CO₂ from the effluent, thereby pushing the chemical equilibrium of ammonium bicarbonate and ammonia significantly toward free ammonia and increase the pH of the digestate fluid, thereby facilitating an extraction of a greater quantity of ammonia from the effluent. The CO₂ in the decarbonization cell 1020 may be prevented from passing from the decarbonization cell 1020 to the later stage cells in the desorption chamber system 1021 by a valve, flap, or other structure 1020b that allows liquid passage while preventing or reducing the movement of gas from the decarbonization cell 1020. The decarbonized digestate may have a reduced pH of about 8 to about 10 (e.g., about 8.5 to about 9.5, or any value in such range).

The decarbonized digestate fluid is left in the decarbonizing cell may flow through the valve 1020b into the next cell 1030, which is an ammonia desorption cell. The increased pH of the decarbonized digestate fluid, in turn, pushes ammonium equilibrium toward dissociation of ammonium into aqueous ammonia and hydrogen ions, making more ammonia available in the digestate fluid and facilitating the recovery of ammonia from the digestate fluid. In some embodiments, one or more basic chemical agents may be used to raise the pH of the digestate pooled in the second collection chamber. In some examples, the basic agent may be NaOH, Ca(OH)₂, KOH, or other basic agent, which may be added in sufficient amounts to raise the pH of the pooled digestate to a pH in the range of about 8 to about 11 (e.g., about pH 8.5 to about pH 9.5) to further shift the ammonia equilibrium toward deionized ammonia. The basic agent may be supplied from the storage container 1051 for the basic agent.

The decarbonized digestion fluid may pass through a series of ammonia desorption cells 1030, 1040, 1050, and 1060 that allow for a churning flow of the ammonia-rich digestate through the cells and around flow dividers 1030a, 1040a, 1050a, and 1060a to maximize the exposure time of the decarbonize digestate to the elevated temperatures of about 70° C. to about 100° C. (e.g., about 80° C. to about 95° C.) and pH of about 8 to about 11 (e.g., about pH 9 to about pH 10) in the ammonia desorption cells 1030, 1040, 1050, and 1060. The decarbonized digestate at a high temperature and an increased pH allows a large majority of the ammonium in the digestate fluid being dissociated into ammonia and hydrogen ions, allowing a proportion of the ammonia in solution that is in the uncharged (non-ionized) ammonia state of about 0.6 or greater. The proportion of ammonia that is in the NH₃ form in a aqueous solution (1) at a temperature in a range of 70° C. to about 80° C. and (2) a pH of about 8 to about 10 (e.g., in a range of about 8.5 to about 9.5) is in a range of about 0.6 to about 0.95. Thus, a large majority of the ammonia in the decarbonized digestate fluid is in recoverable form after it is exposed to high temperatures and pH. Additionally, the solubility of NH₃ in an aqueous solution is low, and thus most of the NH₃ volatilizes from the digestate fluid, escaping the digestate fluid as NH₃ vapor. An ammonia-rich air mixture is collected from the cells 1030, 1040, 1050, and 1060, through a conduit to the ammonia stripping and recovery stage 1070. The removal of the ammonia-rich vapor may be aided by a pump, applied partial vacuum, or may be allowed to flow naturally from the cells.

In some embodiments, some or all of the fluid remaining in the cells 1030, 1040, 1050, and 1060 may be removed from the chamber and routed either back to the digester 1001 or delivered into a filtering apparatus for purification. The filtering apparatus may be any of various known filtering apparatus. In some embodiments, the filter apparatus may be a filter press. In some embodiments, once the recovered fluid is filtered, yielding a water filtrate, the water may be conditioned to a target temperature and routed to one or more subsequent uses. The recovered digestate fluid may be conditioned in a heating system (e.g., a heat exchanger electrical heating system, etc.) to a temperature in a range of about 35° C. about 45° C. and routed in a tank for storage. The fluid may be added back to the digester 1001 to be mixed with the biodigestion medium as needed.

The NH₃ may be transported to a stripping and concentrating vessel 1070 operable to produce a concentrated organic liquid ammonia product. Due to the high pH conditions of about 8 to about 11 (e.g., about pH 9 to about pH 10), temperatures of about 70° C. to about 100° C. (e.g., about 80° C. to about 95° C.), and high NH₃ concentration in the vessel 1070, significant amounts of NH₃ volatilize from the fluid therein and may be collected via an outlet that leads to a Venturi injector or other mixer that injects steam (e.g., from heat apparatus 1008) into the NH₃ vapor to drive NH₃ vapor out of the collected fluid that includes ammonia and ammonium species (e.g., ammonium, ammonium hydroxide, and ammonium carbonate). The NH₃-rich vapor in the vessel 1070 may be collected from the vessel 1070 and passed through a cooling mechanism (e.g., a heat exchanger, refrigeration unit, or other cooling mechanism) and then then collected in a tank 1080.

A substantial amount of the NH₃ in the collected vapor mixture is able to be dissolved into the cooled, lower pH aqueous solution. The Ammonia solubility in aqueous solutions increases as temperature and pH drop. The proportion of ammonia that is in the NH₄⁺ form in a aqueous solution (1) at a temperature in a range of 20° C. and (2) a pH of less than about 8.5 is more than about 0.8. Thus, the solubility of NH₃ in aqueous solution is also high, and thus a significant proportion of the NH₃ in the NH₃-rich air dissolves into the ammonia solution. This chemical characteristic is taken advantage of in the presently disclosed invention to recapture the degassed ammonia in an aqueous solution that can be practically used in a number of applications including making organic nitrogen fertilizers. The ammonia-rich aqueous solution may be transported incrementally to a holding tank for the clean aqueous ammonia product.

The ammonia produced by this process is an organic ammonium hydroxide solution that is usable in organic farming. The ammonia is produced at a concentration in a range of about 15-30% w/w ammonia solution. The organic ammonia solution may be used to create fertilizer compositions that are compliant with the Organic Foods Production Act of 1990, USDA Organic Regulations, (generally referred to as the National Organic Program or NOP) and other agency standards for use in organic farming and can be used in organic farming operations. In some embodiments, the ammonium hydroxide composition may be mixed with other plant and soil nutrient compounds that are compatible with organic farming to create a nitrogen-rich organic fertilizer composition.

In some embodiments, and without limitation, a fertilizer composition may include a liquid composition that includes about 3% to about 30% ammonia w/w (e.g., 10% w/w to about 25% w/w, or any value or range of values therein), and/or one or more additional ingredients. The fertilizers may further include organic acids that may serve to balance the pH effects of the concentrated ammonia in the fertilizer. The pH may be maintained in a range around neutral pH, such as between about pH 6 and pH 8 (e.g., from about pH 6.5 to about pH 7.5). To balance the pH of the liquid fertilizer, the liquid fertilizer may include one or more organic acids. Because the ammonia is organically derived from biowastes and natural sources, the concentration of the stable ¹⁵N isotope in the resulting ammonia composition is much higher than in ammonia products that are made from chemical syntheses and concentration techniques. The ¹⁵N isotope is present in the environment and in ammonia products generated by chemical reactions in an amount of about 0.3% per mole of naturally occurring nitrogen. The amount of ¹⁵N isotope in the ammonia and related species present in recovered nitrogen constituents of the present invention is several times greater than in ammonia products produced by chemical reactions or in natural concentration. The ¹⁵N isotope in the ammonia and related species present in recovered nitrogen constituents of the present invention is in the range of about 1% to about 20% per mole of nitrogen (e.g., in a range of about 5% to about 15%). The high concentration of ¹⁵N isotope reflects the process of concentrating ammonia from natural biowastes and nutrient stocks through organic processes.

The resulting high concentration ammonia composition may be further processed into fertilizer products. In some embodiments, the fluid product captured from the third mixing chamber may be utilized as a fertilizer composition. Such fertilizer composition may be an aqueous solution comprising ammonia in various ionic forms in a concentration of about 3% to about 30% w/w (e.g., 10% w/w to about 25% w/w, or any value or range of values therein), and carbonic acid in various soluble forms in an amount of about 5% to about 15% w/w.

In other embodiments, the organic fertilizers may include ammonia in various ionic forms in a concentration of about 3% to about 30% w/w (e.g., 10% w/w to about 25% w/w, or any value or range of values therein) and one or more weak organic acids or salts thereof (e.g., polyprotic organic acids or salts thereof), such as citric acid, malic acid, fumaric acid, salts of such organic acids, and combinations thereof. Other simpler organic acids, such as acetic acid salts of such organic acids may be used as well. The organic acids must be from organically-compliant sources (e.g., NOP compliant). Citric acid may be preferred due to its tri-protic chemistry and superior buffering capabilities. The organic acid(s) may be present in a concentration in the liquid fertilizer in a range of about 5% to about 50% w/w, depending on the concentration of ammonia in the liquid fertilizer. For example, the concentration of citric acid in the liquid fertilizer by weight may be about twice the amount of ammonia present in the solution by weight. Simpler monoprotic acids may be present in higher concentrations, due to their lower buffering capacity.

The organic fertilizers of the present invention may also include humic acids which help with nitrogen fixation in the organic fertilizers. Liquid ammonia fertilizers suffer from nitrogen loss through the evaporation or other pathways of loss. Planting soils are typically acidic to optimize conditions for the growth of plants, which exhibit optimal germination and growth in a pH range of about pH 5.0 to about pH 7.0. The acidic pH of the soil can increase ammonia volatilization. This particularly significant where the fertilizer composition has a relatively high nitrogen concentration (e.g., greater than 10% w/w), since the higher concentration results in a higher rate of volatilization. Humic acids are able to retain NH₄ as well as aid in NH₃ ammonia volatilization reduction. Humic acids have high cation exchange capacity (CEC) that allows it to retain soil cations and can significantly reduce NH₃ volatilization upon addition to an acidic soil (e.g., through the addition of peat). The addition of humic acids to the organic NH₃ fertilizer of the present invention significantly reduces NH₃ volatilization and lead to effective accumulation of NH₄ in the planting soil, despite having an acidic pH (e.g., about pH 5.5 to about 7.0). The humic acids may provide the additional benefit of providing short carbon-chain molecules

Humic acids may be added included in the organic fertilizer composition of the present invention in a concentration in a range of about 3% w/w to about 8% w/w. The amount of humic acids included in the organic fertilizer may vary with the concentration of ammonia provided therein. For example, in compositions comprising about 10% to about 15% NH₃ w/w, the fertilizer composition may include about 3% to about 4% w/w of humic acids. In compositions comprising about 15% to about 25% organic NH₃ w/w, the fertilizer composition may include about 5% to about 8% w/w of humic acids.

The organic fertilizer composition of the present invention may also include additional components routinely used in the art, for example, humectants, adjuvants, antioxidants, stabilizers, plant macronutrients, plant micronutrients, and combinations thereof.

The organic fertilizer composition of the present invention may also include a solid fertilizer composition comprising about 3% to about 30% ammonia w/w (e.g., 10% w/w to about 25% w/w, or any value or range of values therein), and/or one or more additional ingredients. The fertilizers may further include organic acids that may serve to balance the pH effects of the concentrated ammonia in the fertilizer. The pH may be maintained in a range around neutral pH, such as between about pH 6 and pH 8 (e.g., from about pH 6.5 to about pH 7.5). The solid fertilizer composition may additionally include humectants, adjuvants, antioxidants, stabilizers, plant macronutrients, plant micronutrients, and combinations thereof. The fertilizer composition may include further nutrients, such as gypsum as a calcium sulfate source, and dolomitic lime as a calcium carbonate and magnesium carbonate source.

### CONCLUSION/SUMMARY

The present invention provides organic ammonia fertilizer compositions and methods of making the same. It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed is:

1. A method of producing organic ammonia, comprising:
a. heating a biowaste material in an anaerobic digester device to drive a biological anaerobic digestion of the biowaste and yield a digested biowaste composition;
b. collecting an effluent of the digested biowaste composition;
c. heating said waste water effluent to evolve CO₂-laden gas from the effluent;
d. heating the decarbonized effluent to extract NH₃ vapor from said decarbonized effluent; and
e. passing the NH₃ vapor into an NH₃ concentrating chamber to extract NH₃ and yield an aqueous NH₃ product derived from effluent without chemical reactions.

2. A liquid organic nitrogenous fertilizer composition, comprising an aqueous solution of the aqueous NH₃ product comprising nitrogen that includes molar percentage of ¹⁵N of about 1% to about 20% of the total molar N in the aqueous NH₃ product.

3. The composition of claim 2, further comprising an organic acid in a concentration of about 6% to about 50%.

4. The composition of claim 3, further comprising humic acids as a chelation agent for the ammonia.

5. The composition of claim 3, wherein said humic acids is present in a concentration of about 3% to about 8%.

6. The composition of claim 2, wherein the concentration of organically produced ammonia is in a concentration of about 10% w/w to about 20% w/w.

7. The composition of claim 3, wherein the concentration of said organic acid is in a concentration of about 20% w/w to about 40% w/w.

8. The composition of claim 7, wherein said organic acid is a triprotic acid.

9. The composition of claim 7, wherein said organic acid is citric acid.

10. The composition of claim 2, wherein the concentration of organically produced ammonia is in a concentration of about 10% w/w to about 20% w/w.

11. The composition of claim 3, wherein the concentration of said organic acid is in a concentration of about 20% w/w to about 40% w/w.

12. The composition of claim 11, wherein said organic acid is a triprotic acid.

13. The composition of claim 12, wherein said organic acid is citric acid.

14. A liquid organic nitrogenous fertilizer composition, comprising an aqueous solution of aqueous NH₃ product produced without chemical reactions and having a concentration of NH₃ and salts and derivatives thereof in a range of about 3% to about 30% by weight.

15. The composition of claim 14, wherein nitrogen present in said composition includes molar percentage of ¹⁵N of about 1% to about 20% of the total molar N in the composition.

16. The composition of claim 14, further comprising an organic acid in a concentration of about 6% to about 50%.

17. The composition of claim 14, further comprising humic acids as a chelation agent for the ammonia.

18. The composition of claim 17, wherein said humic acids is present in a concentration of about 3% to about 8%.

19. The composition of claim 14, wherein the concentration of organically produced ammonia is in a concentration of about 10% w/w to about 20% w/w.

20. The composition of claim 16, wherein the concentration of said organic acid is in a concentration of about 20% w/w to about 40% w/w.

21. The composition of claim 20, wherein said organic acid is a triprotic acid.

22. The composition of claim 20, wherein said organic acid comprises citric acid.
